(19) United States
(12) Patent Application Publication
(10) Pub. No.: US 2025/0368230 A1
(43) Pub. Date: Dec. 4, 2025

(54) CAUSAL TRAJECTORY PREDICTION

(71) Applicant: Honda Motor Co., Ltd., Tokyo (JP)

(72) Inventors: Zizhao WANG, Austin, TX (US); Aolin XU, Santa Clara, CA (US); Enna SACHDEVA, Santa Clara, CA (US); Teruhisa MISU, San Jose, CA (US)

(21) Appl. No.: 19/084,329

(22) Filed: Mar. 19, 2025

Related U.S. Application Data
(60) Provisional application No. 63/652,500, filed on May 28, 2024.

(51) Int. Cl. B60W 60/00; B60W 50/00

(52) U.S. Cl. CPC B60W 60/0027; B60W 50/0097; B60W 2556/45

(57) ABSTRACT

According to one aspect, causal trajectory prediction may include generating a sparsified causal graph including two or more nodes and two or more edges. A node of the two or more nodes may represent an agent of one or more agents within an environment. An edge of the two or more edges between a first node and a second node may represent a causal relationship between the first node and the second node. The computer-implemented method for causal trajectory prediction may include generating one or more agent future features based on the sparsified causal graph and an encoder and generating a trajectory prediction for a target agent based on the one or more agent future features and a decoder.

### CROSS REFERENCE TO RELATED APPLICATIONS

This application claims the benefit of U.S. Provisional Patent Application, Ser. No. 63/652,500 (Attorney Docket No. HRA-56106) entitled “CAUSAL TRAJECTORY PREDICTION”, filed on May 28, 2024; the entirety of the above-noted application(s) is incorporated by reference herein.

### BACKGROUND

Making accurate predictions of surrounding agents may be a task associated with autonomous driving, and may be useful in complex interactive traffic scenarios. For example, motion prediction may be useful for an autonomous driving system. Motion prediction may include predicting the multi-modal future trajectories of other agents (e.g., vehicles, pedestrians, and cyclists) near the autonomous vehicle based on heterogeneous observations, including but not limited to high-definition (HD) maps, traffic lights, and the historical trajectories of other agents. Accurate motion prediction may be useful for efficient navigation of an autonomous vehicle, but it may also be challenging, as a model reasons about the interactions between agents in complex scenarios.

### BRIEF DESCRIPTION

According to one aspect, a system for causal trajectory prediction may include a processor and a memory. The memory may store one or more instructions. The processor may execute one or more of the instructions stored on the memory to perform one or more acts, actions, and/or steps. The processor may generate a sparsified causal graph including two or more nodes and two or more edges. A node of the two or more nodes may represent an agent of one or more agents within an environment. An edge of the two or more edges between a first node and a second node may represent a causal relationship between the first node and the second node. The processor may generate one or more agent future features based on the sparsified causal graph and an encoder. The processor may generate a trajectory prediction for a target agent based on the one or more agent future features and a decoder.

According to one aspect, the system for causal trajectory prediction may include an actuator and the processor may control the actuator to cause the system for causal trajectory prediction to perform a driving maneuver based on the trajectory prediction for the target agent. The processor may generate the sparsified causal graph based on regularized Bernoulli distribution. The processor may generate the sparsified causal graph based on an entmax function or a softmax function. The processor may generate a coarse trajectory prediction for one or more of the agents within the environment based on one or more of the agent future features. The processor may generate the trajectory prediction for the target agent based on the coarse trajectory prediction for one or more of the agents. The processor may generate the sparsified causal graph based on an adjacency matric and sparse self-attention. The system for causal trajectory prediction may be equipped on an autonomous vehicle. The encoder may include one or more encoder layers and in each encoder layer, a message may be only passed from each agent's parents to each agent itself. The decoder may include one or more decoder layers and in each decoder layer, a message may be only passed from each agent's parents to each agent itself.

According to one aspect, a computer-implemented method for causal trajectory prediction may include generating a sparsified causal graph including two or more nodes and two or more edges. A node of the two or more nodes may represent an agent of one or more agents within an environment. An edge of the two or more edges between a first node and a second node may represent a causal relationship between the first node and the second node. The computer-implemented method for causal trajectory prediction may include generating one or more agent future features based on the sparsified causal graph and an encoder and generating a trajectory prediction for a target agent based on the one or more agent future features and a decoder.

The computer-implemented method for causal trajectory prediction may include controlling an actuator to cause a vehicle for causal trajectory prediction to perform a driving maneuver based on the trajectory prediction for the target agent. The generating of the sparsified causal graph may be based on regularized Bernoulli distribution. The generating of the sparsified causal graph may be based on an entmax function or a softmax function. The computer-implemented method for causal trajectory prediction may include generating a coarse trajectory prediction for one or more of the agents within the environment based on one or more of the agent future features and generating the trajectory prediction for the target agent based on the coarse trajectory prediction for one or more of the agents.

According to one aspect, a system for causal trajectory prediction may include an actuator, a memory, and a processor. The memory may store one or more instructions. The processor may execute one or more of the instructions stored on the memory to perform one or more acts, actions, and/or steps. The processor may generate a sparsified causal graph including two or more nodes and two or more edges. A node of the two or more nodes may represent an agent of one or more agents within an environment. An edge of the two or more edges between a first node and a second node may represent a causal relationship between the first node and the second node. The sparsified causal graph may include less edges than a full causal graph associated with the same one or more agents within the environment. The processor may generate one or more agent future features based on the sparsified causal graph and an encoder. The processor may generate a trajectory prediction for a target agent based on the one or more agent future features and a decoder. The processor may control the actuator to cause the system for causal trajectory prediction to perform a driving maneuver based on the trajectory prediction for the target agent.

The processor may generate the sparsified causal graph based on regularized Bernoulli distribution. The processor may generate the sparsified causal graph based on an entmax function or a softmax function. The processor may generate a coarse trajectory prediction for one or more of the agents within the environment based on one or more of the agent future features. The processor may generate the trajectory prediction for the target agent based on the coarse trajectory prediction for one or more of the agents.

### BRIEF DESCRIPTION OF THE DRAWINGS

FIG. 1 is an exemplary component diagram of a system for causal trajectory prediction, according to one aspect.

FIGS. 2A-2D are exemplary architectures associated with the system for causal trajectory prediction of FIG. 1, according to one aspect.

FIG. 3 is an exemplary flow diagram of a computer-implemented method for causal trajectory prediction, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

A model associated with systems, methods, and/or techniques for causal trajectory prediction may model one or more interactions among agents to make accurate predictions. State-of-the-art trajectory prediction models may utilize model architectures with large capacity to capture those interactions from data, without deliberately distinguishing which agents are causal to a target agent's future motion. However, even in dense traffic scenarios, each agent may be influenced by merely a few other agents. Thus, prediction models with dense dependencies become inevitably vulnerable to spurious correlations. In this regard, a causal prediction model that makes predictions based on the minimal set of relevant agents is provided herein.

According to one aspect, a system for causal trajectory prediction is provided herein, including a framework that infers such causal relationships between agents and may be incorporated into a wide range of motion prediction models. The system for causal trajectory prediction may utilize an instance-dependent causal graph predictor to select the set of relevant agents while keeping the set minimal with sparsity regularization. A graph predictor may be trained jointly with motion prediction end-to-end, without requiring causal graph labels. Compared to others that identify relevant agents with limited heuristics, the system for causal trajectory prediction's identification provides the advantage of better aligning with human judgment, due to the set of relevant agents being selected while implementing sparsity regularization. In this way, the system for causal trajectory prediction improves the robustness of the backbone model while maintaining prediction accuracy.

In many scenarios, though a large number of agents may be present in the scene (e.g., at a busy intersection or in a crowded parking lot), each agent may only be influenced by a few or even none of the other agents. To make an accurate prediction, it may be useful for the model to identify the causal relationships between agents (e.g., for each agent, find out which agents influence it) so that the model may estimate how its future motion may be influenced, conditioning on those agents.

To capture interactions between agents accurately and enhance motion prediction accordingly, the system for causal trajectory prediction is provided herein. The system for causal trajectory prediction conducts instance-dependent causal discovery to reason about, in the given scenario, which agents influence which other agents. Specifically, for each agent, a graph predictor may predict its parents (e.g., agents directly influencing that agent). Then, when predicting future trajectories, the motion predictor only lets each agent attend to its ancestors, as specified by the predicted graph, making its prediction unaffected by irrelevant agents. To identify causal relationships, following prior causal discovery works, the graph predictor may be trained to generate the sparsest graph that enables the motion predictor to make efficient, accurate predictions. In this way, the graph predictor may learn to include relevant agents for accurate motion prediction and exclude irrelevant agents for graph sparsity. To enable the graph predictor to achieve both objectives, various sparsification techniques may be implemented, such as the regularized Bernoulli method, for example. Meanwhile, with the causal graph predictor identifying the relevant agents, the motion predictor may focus its learning on estimating how they interact with a reduced input space, which improves its generalization.

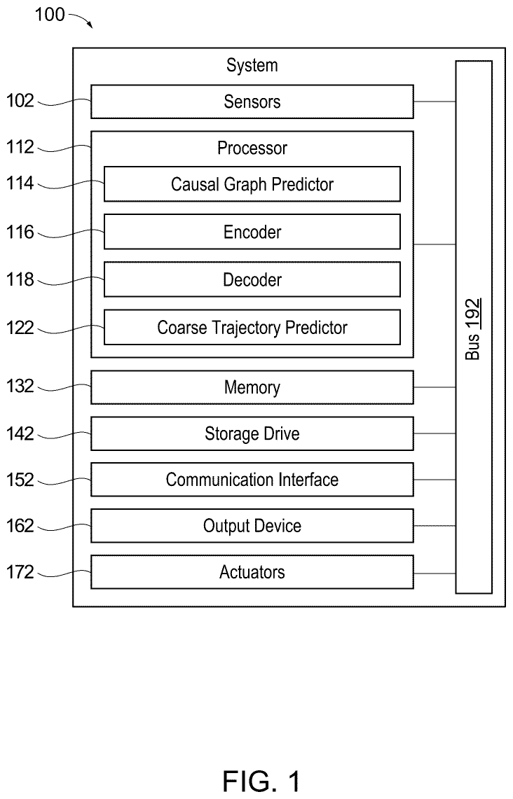

FIG. 1 is an exemplary component diagram of a system 100 for causal trajectory prediction, according to one aspect. The system 100 for causal trajectory prediction may include one or more sensors 102 and a processor 112. The processor 112 may include a causal graph predictor 114, an encoder 116, a decoder 118, and a coarse trajectory predictor 122. The causal graph predictor 114, the encoder 116, the decoder 118, and the coarse trajectory predictor 122 may be implemented via the processor 112. The system 100 for causal trajectory prediction may include a memory 132, a storage drive 142, a communication interface 152, one or more output devices 162, and one or more actuators 172. One or more of the respective components (e.g., the sensors 102, the processor 112, the memory 132, the storage drive 142, the communication interface 152, the output devices 162, the actuators 172, etc.) may be operably connected via a bus 192 thereby enabling computer communication therebetween.

One or more of the sensors 102 may sense or detect one or more agents, one or more traffic participants, or one or more features within an environment or operating environment. For the sake of discussion, merely agents are described herein, but other traffic participants or features within the environment may be considered similarly. For example, the sensors 102 may detect one or more vehicles, one or more pedestrians, one or more bicyclists, one or more motorcyclists, etc. around an ego-vehicle within a driving environment. The sensors 102 may determine one or more attributes associated with each agent. Examples of attributes may include a position, a velocity, an acceleration, a lane position, a turn signal status, a behavior, etc.

According to another aspect, information associated with one or more of the agents, one or more of the traffic participants, or one or more features within the environment may be received via the communication interface 152 and stored on the storage drive 142.

The memory 132 may store one or more instructions. The processor 112 may execute one or more of the instructions stored on the memory 132 to perform one or more acts, actions, and/or steps.

### Motion Prediction Problem Formulation

For a motion prediction problem, a task may be to predict the future two-dimensional (2D) positions individually for each target agent based on the map and the history trajectories of agents (e.g., for presentation simplicity, in this disclosure, the traffic light states may be included in the map) and the processor 112 may formulate the problem as follows:

According to one aspect, vectorized representation of traffic scenes may represent input features as vectors. Specifically, in each scenario, agent history may be represented as Aᵢₙ∈ [symbol] ^{N}^{ₐ}^{×t×d}^{ₐ}, where Nₐ may be the number of agents, t may be the number of history frames, and da may be the dimension of agent state information (e.g., location, heading angle, and velocity). The road map may be defined as a composition of geometric shapes (e.g., crosswalks as polygons, road boundaries as polylines, and traffic lights as points), with each element represented by a vector. Formally, the map may be denoted as Mᵢₙ∈ [symbol] ^{N}^{ₘ}^{×N}^{ₚ}^{×d}^{ₘ}, where Nₘ may be the number of map elements, Nₚ may be the number of points in the vector of a single map element¹, and dₘ may be the number of map attributes in each point (e.g., location and road type). The multimodal prediction for each target agent, without loss of generality, may be represented in the form of a Gaussian mixture model, denoted as Âₒᵤₜ∈ [symbol] ^{K×T×d}^{ₒᵤₜ}, where K may be the number of modes, T may be the number of future frames, and dₒᵤₜ may be the number of to-predict attributes (e.g., mean and variances of the position).

Further, any of the calculations or problem formulations described herein may be performed via the processor 112, the memory 132, the storage drive 142, etc.

### Encoder-Decoder Architectures

The encoder 116 may extract scene features from inputs and the decoder 118 predicts the future motion of each target agent. Specifically, the encoder 116 may include multiple layers, with each modeling the message passing between inputs as follows:

for each agent i=1, . . . , Nₐ,

$${A}_{j}^{i} = {f}_{enc , j} ( {\{ {A}_{j - 1}^{n} \}}_{n = 1}^{{N}_{a}} , {\{ {M}_{j - 1}^{n} \}}_{n = 1}^{{N}_{m}} ) \qquad ( 1 )$$

where f_{enc,j} may be the j-th encoder layer, Aⱼⁱ may be the embedding of the agent i after j encoding layers, and each agent's embedding may be initialized with its historical trajectory, e.g., A₀ⁱ=Aᵢₙⁱ. The map features may be initialized and updated in a similar way, except that others agent features from the inputs to the map encoder. The encoder layers f_{enc,j} may use any neural model.

To generate predictions for each target agent i from the extracted scene features, the decoder 118 may initialize the prediction with a learnable embedding Q and refine it through multiple layers to produce the final prediction. In each layer, the embedding may be refined by attending to agent features A_{enc} and map features M_{enc} computed by the encoder 116 as follows:

for each agent i=1, . . . , Nₐ,

$${Q}_{j}^{i} = {f}_{dec , j} ( {Q}_{j - 1}^{i} , {\{ {A}_{enc}^{n} \}}_{n = 1}^{{N}_{a}} , {\{ {M}_{enc}^{n} \}}_{n = 1}^{{N}_{m}} ) \qquad ( 2 )$$

where Qⱼⁱ may be the prediction embedding after the j-th update using layer f_{dec,j}, and f_{dec,j} may be implemented as cross-attention. Regardless, a network may map the final embedding to prediction Âₒᵤₜ. The encoder-decoder may be trained end-to-end by minimizing the negative log-likelihood of the prediction, denoted as [symbol] _{pred}(Aₒᵤₜ,Âₒᵤₜ).

Computing each agent's features and prediction embeddings in Equations (1-2), and using other agents' features as inputs, even though agent i may be only influenced by a few other agents may cause a model to be computationally burdensome and vulnerable to spurious correlations. Thus, the processor 112 may generate a sparsified causal graph including two or more nodes and two or more edges. A node of the two or more nodes may represent an agent of one or more agents within the environment. An edge of the two or more edges between a first node and a second node may represent a causal relationship between the first node and the second node. The sparsified causal graph may include less edges than a full causal graph associated with the same one or more agents within the environment.

### Causal Graphical Model (CGM)

The processor 112 may assume a problem of interest described by a random vector X∈ [symbol] ^{d}^{ₓ} entailed by an underlying Causal Graphical Model (P_{X}, [symbol] ), where P_{X} models the data generation over X under a directed acyclic graph [symbol] . In the graph [symbol] , each node j corresponds to exactly one variable in the system, and each edge from i to j indicates that variable Xⁱ influences the generation process of X^{j}. Let PA^{j} denote the set of parents of node j in [symbol] . The processor 112 may assume there are no hidden variables. Then, in a CGM, P_{X} follows

$$p ( x ) = {\prod }_{j = 1}^{d} p ( {x}^{j} \vert {PA}^{j} ) ,$$

where p(x^{j}|PA^{j}) may be the conditional distribution of variable X^{j} given PA^{j}. Given a dataset

$$𝒟 = {\{ {x}_{n} \}}_{n = 1}^{{N}_{D}} ,$$

causal discovery aims to recover the ground-truth causal graph [symbol] modeling which variables influence which, in their generation process.

### Causal Motion Predictor

The system 100 for causal trajectory prediction may infer causal relationships between agents in the scene and uses the inferred relationships to facilitate motion prediction by excluding irrelevant agents from inputs.

The processor 112 may define the problem setup of causal discovery in the context of motion prediction. Following the causal graphical model formulation, in each motion prediction scenario, the random variables (e.g., graph nodes) X may include each agent's history

$${\{ {A}_{in}^{i} \}}_{i = 1}^{{N}_{a}} ,$$

the map Mᵢₙ, and each agent's future motion

$${\{ {A}_{out}^{i} \}}_{i = 1}^{{N}_{a}} .$$

The causal motion predictor may identify agent interactions to simplify graph inference by making two observations or assumptions: (1) the future motions of agents may be influenced by the map, and (2) the agent history and the map may not be influenced by the future motion of any agent. As a result, these assumptions may simplify the problem to the identification of the sub-causal-graph [symbol] ∈{0,1}^{N}^{ₐ}^{×N}^{ₐ}, where each entry denotes whether agent i's history influences agent j's future motion (for notation simplicity, overload [symbol] as this subgraph, unless specified otherwise).

Since different scenarios have different agent interactions, the goal may be to learn a graph predictor [symbol] : Aᵢₙ×Mᵢₙ→ [symbol] such that the predicted instance-dependent graph [symbol] recovers the ground truth graph [symbol] for each scenario.

### Encoder-Decoder Motion Predictor

Predicted causal relationships may be applied to enhance motion prediction. For example, the system 100 for causal trajectory prediction may be designed as a versatile framework that serves as a plug-and-play solution to improve prediction robustness for the family of prediction models with little effort. According to one aspect, the processor 112 may first query the learned graph predictor [symbol] , and confine the model to update an agent's features using only the information of its causal parents as determined by the inferred causal graph [symbol] . By doing so, this ensures that the prediction process aligns with the CGM specified by [symbol] . However, prediction models may include multiple encoding and decoding layers, involving multiple rounds of message passing. Thus, it may not be straightforward to ensure the model's consistency with the inferred causal graph.

To this end, the processor 112 may instead learn to predict the causal graph implicitly. Specifically, train a predictor [symbol] : Aᵢₙ×Mᵢₙ→ [symbol] ₒ that outputs a graph [symbol] ₒ defined on the same set of nodes as the causal graph [symbol] , which refer to as the one-hop graph. Then, the processor 112 may confine each layer of the encoder 116 and decoder 118 to update agent i's features using the features of its parents, denoted by PAⁱ, resulting in:

$${A}_{enc , j}^{i} = {f}_{enc , j} ( {\{ {A}_{enc , j - 1}^{i} \}}_{n ∈ {PA}^{i}} , {\{ {M}_{enc}^{i} \}}_{n = 1}^{{N}_{m}} ) \qquad ( 3 )$$

$${Q}_{j}^{i} = {f}_{dec , j} ( {Q}_{j - 1}^{i} , {\{ {A}_{enc}^{i} \}}_{n ∈ {PA}^{i}} , {\{ {M}_{enc}^{i} \}}_{n = 1}^{{N}_{m}} ) \qquad ( 4 )$$

Additionally, agent features may be excluded from the inputs to the map encoder.

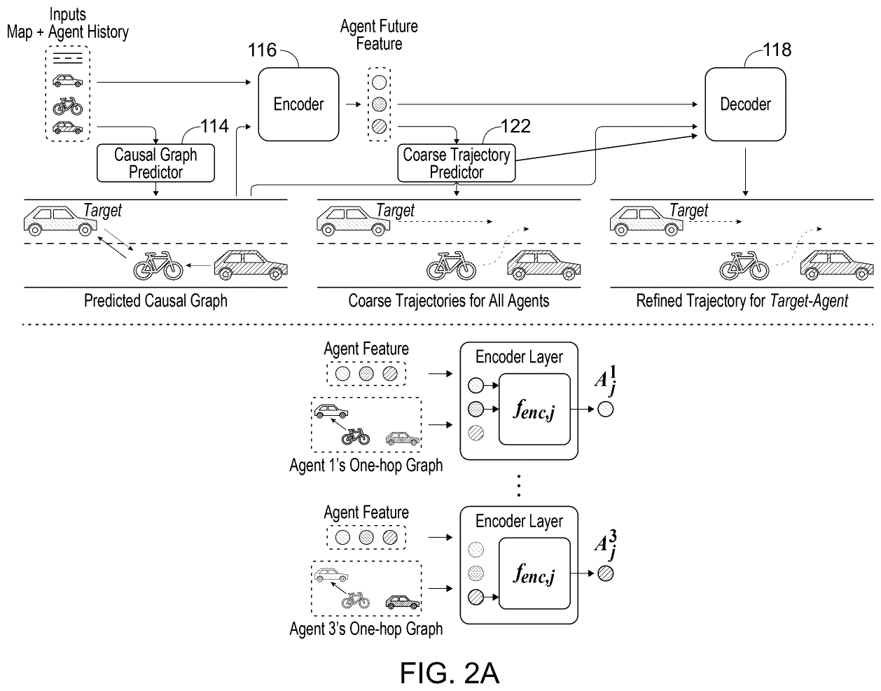

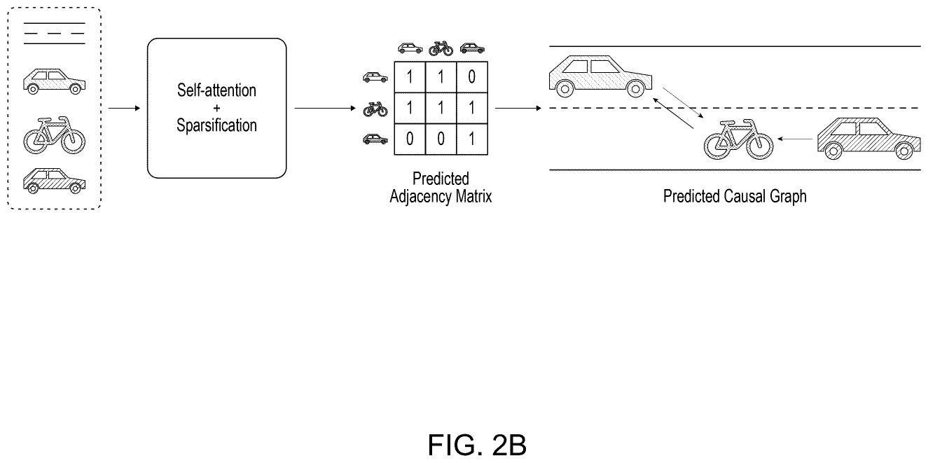

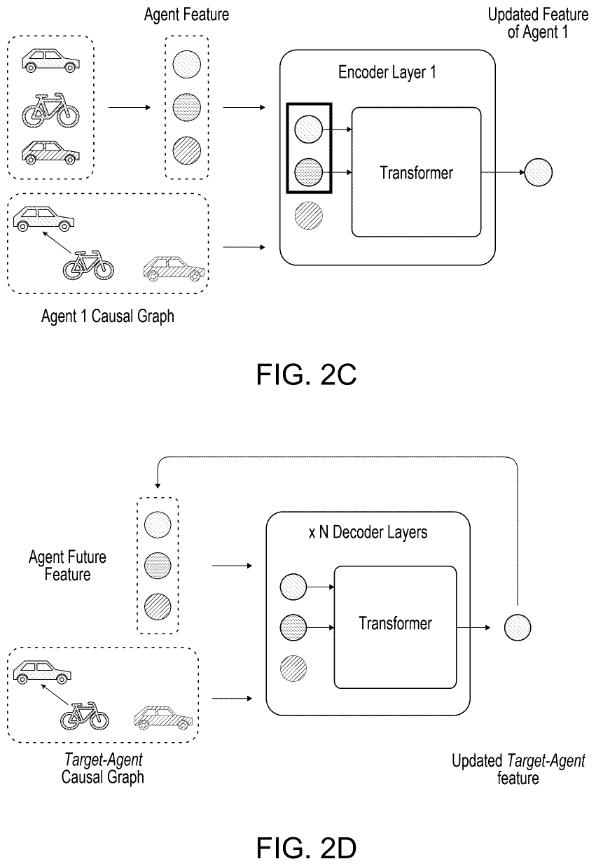

In Equation (3), depending on the number of encoder layers, the prediction of agent i may not only condition on its parents PAⁱ but also its grandparents, or even ancestors on [symbol] ₒ. Intuitively, this enlarged conditioning set enables the prediction model to conduct multi-hop reasoning—thus refer to [symbol] ₒ. as the one-hop graph. Taking the scene in FIG. 2 as an example, in the first layer, the edge “vehicle→bicycle” represents that the bicycle's trajectory may be affected by (e.g., deviates from its straight path because of) the parked vehicle, then the edge “bicycle→other vehicle” may represent that the other vehicle slows down for the bicycle. Together with the multi-layer encoder 116 and decoder 118, the inferred [symbol] ₒ implicitly specifies the actual causal graph [symbol] . Formally, an agent j's history may be causal to agent i's future motion, if agent j may be a kth ancestor of agent i on [symbol] ₒ for any k≤N_{enc}+1, where N_{enc} may be the numbers of encoding layers.

### Identification of Causal Relationships

The ground truth causal relationship between agents G may be recovered under some scenarios or conditions, and the system 100 for causal trajectory prediction may learn to recover it.

Identifiability of

[symbol]

For a general causal graph model (P_{X}, [symbol] ) for a variable X the causal graph may be identified with the following assumptions by the processor 112: (1) there is no hidden variable; and (2) the data generation process for each variable Xⁱ follows the format p(Xⁱ|PAⁱ)=fⁱ(PAⁱ)+Nⁱ, where fⁱ is a nonlinear function satisfying some mild conditions and Nⁱ may be Gaussian noise independent of X.

The graph may be identified by minimizing the following Bayesian Information Criterion (BIC) score:

$${S}_{BIC} ( 𝒢 ) = - log {p}_{\hat{θ}} ( X ; G ) + λ \vert 𝒢 \vert \qquad ( 5 )$$

where \hat{θ} may be the maximum likelihood estimator of P_{X} for the given [symbol] , | [symbol] | may be the number edges, and λ may be the coefficient of edge regularization.

Identification of

[symbol]

The casual graph may be predicted implicitly by training [symbol] to predict the one-hop graph. Specifically, design the one-hop graph predictor [symbol] as a stack of cross-attention layers, in which each agent i's history may be fed as the initial query, cross-attended to inputs to infer causal relationships, as follows:

for each agent i=1, . . . , Nₐ,

$${A}_{{𝒢}_{o} , j}^{i} = {f}_{{𝒢}_{o} , j} ( query = {A}_{{𝒢}_{o} , j - 1}^{i} , keys = [ {A}_{in} , {M}_{in} ] ) \qquad ( 6 )$$

where

$${A}_{{𝒢}_{o} , j}^{i}$$

may be the feature of the agent i after being passed through j cross-attention layers and [⋅,⋅] denotes input concatenation. Finally, the last layer's agent-to-agent attention score s∈ [symbol] ^{N}^{ₐ}^{×N}^{ₐ} may be passed to a normalization function fₙₒᵣₘ to compute the one-hop graph, [symbol] ₒ=fₙₒᵣₘ(s).

According to one aspect, the processor 112 may generate the sparsified causal graph based on regularized Bernoulli distribution. According to one aspect, the processor 112 may generate the sparsified causal graph based on an entmax function or a softmax function. The processor 112 may generate the sparsified causal graph based on an adjacency matric and sparse self-attention.

In the context of motion prediction, the first term of Equation (5) measures the negative log-likelihood of the prediction and may be the same as the prediction loss [symbol] _{pred}. This term indicates that, if a predicted causal graph [symbol] may be the sparsest graph that enables accurate prediction, it recovers the ground truth causal relationships. Inspired by this observation, consider the following sparsification techniques for the normalization function fₙₒᵣₘ: [symbol] ^{N}^{ₐ}^{×N}^{ₐ}→{0,1}^{N}^{ₐ}^{×N}^{ₐ} to induce a sparse [symbol] ₒ, which implicitly induces a sparse [symbol] :

### Regularized Bernoulli

In form, each edge may be produced independently as

$${\hat{𝒢}}_{o}^{ij} = ST ( sigmoid ( {s}^{ij} ) ) ,$$

where s^{ij} may be each individual attention score and ST(⋅) may be the Straight Through estimator. The causal graph predictor 114 and the motion predictor may be trained jointly by minimizing the following loss function derived from Equation (5):

$$ℒ ( {A}_{out} , {\hat{A}}_{out} , {\hat{𝒢}}_{o} ) = {ℒ}_{pred} ( {A}_{out} , {\hat{A}}_{out} ) + λ \vert {\hat{𝒢}}_{o} \vert \qquad ( 7 )$$

where the second term regularizes the attention to be sparse.

### α-ENTMAX

There may be a family of mappings from d-dimensional vector [symbol] ^{d} to its probability simplex Δ^{d}, parametrized by a scalar α. This family may include SoftMax (α=1) and generates sparse mappings when α>1. When fₙₒᵣₘ may be implemented with α-entmax, for each agent i, produce its causal parents as

$${\hat{𝒢}}_{o}^{i} = ST ( α - ent max ( {s}^{i} ) ) ,$$

where

$${\hat{𝒢}}_{o}^{i}$$

and sⁱ may be corresponding rows of the agent. Since the sparsity level may be controlled by α, do not count on the edge regularization term but adjust α to induce sparsity. Thus, the training loss may be the same as in Equation 7 but with λ=0.

$$α - ent max ( z ) := \begin{matrix}arg max {p}^{T} z \\ p ∈ {Δ}^{d}\end{matrix} + {H}_{a}^{T} ( p ) \qquad ( 8 )$$

The goal is to map d real numbers z=(z₁, . . . , z_{d}) to a probability vector p=(p_1, . . . , p_d), such that:

each element in p roughly reflects the value of each element in z, (e.g., if z₁ is relatively large in z, then p₁ should also be relatively large in p); and

p should be a sparse vector, meaning that most of the elements in p should be close to 0.

Equation (8) provides a way to realize such a mapping, which is termed as alpha-entmax (z). Equation (8) states that such a p may be found by maximizing <p,z>+Hₐₗₚₕₐ₍ₚ₎,

where <p,z> is the inner product of the vectors p and z, which may also be viewed as the expectation of z under the distribution p; and

H_alpha(p) is the alpha-Tsallis entropy of p, and the maximizing p* is denoted as alpha-entmax(z).

The above definition p*=alpha-entmax (z) is used herein, where z=( . . . , z_ij, . . . ) are the attention scores between the nodes (e.g., node i and node j) computed from the attention mechanism, and the resulting sparse vector p* is used to decide if an edge between each pair of nodes should be included in the graph.

The processor 112 may generate one or more agent future features based on the sparsified causal graph and the encoder 116. The encoder 116 may include one or more encoder layers and in each encoder layer, a message may be only passed from each agent's parents to each agent itself.

The processor 112 may generate a coarse trajectory prediction for one or more of the agents within the environment based on one or more of the agent future features.

The processor 112 may generate a trajectory prediction for a target agent based on the one or more agent future features, the coarse trajectory prediction for one or more of the agents, and the decoder 118. The decoder 118 may include one or more decoder layers and in each decoder layer, a message may be only passed from each agent's parents to each agent itself.

The system 100 for causal trajectory prediction may be equipped on an autonomous vehicle. The processor 112 may control the actuator 172 to cause the system 100 for causal trajectory prediction to perform a driving maneuver based on the trajectory prediction for the target agent. The processor 112 may control the output device 162 to output information associated with the driving maneuver or the causal trajectory prediction.

FIGS. 2A-2D are exemplary architectures associated with the system for causal trajectory prediction of FIG. 1, according to one aspect.

As seen in FIG. 2A, the causal graph predictor may predict a sparsified causal graph, the coarse trajectory predictor 122 may extract a feature of agent future by making coarse prediction, and the decoder 118 may refine the coarse prediction into a trajectory prediction for a target. In FIG. 2B, the predictor may model the graph as an adjacency matrix and predicts the graph using sparse self-attention. In FIGS. 2C-2D, exemplary encoder architecture is illustrated, where the encoder may include N layers and, in each layer, each agent's feature is updated based on the features of its causal parents.

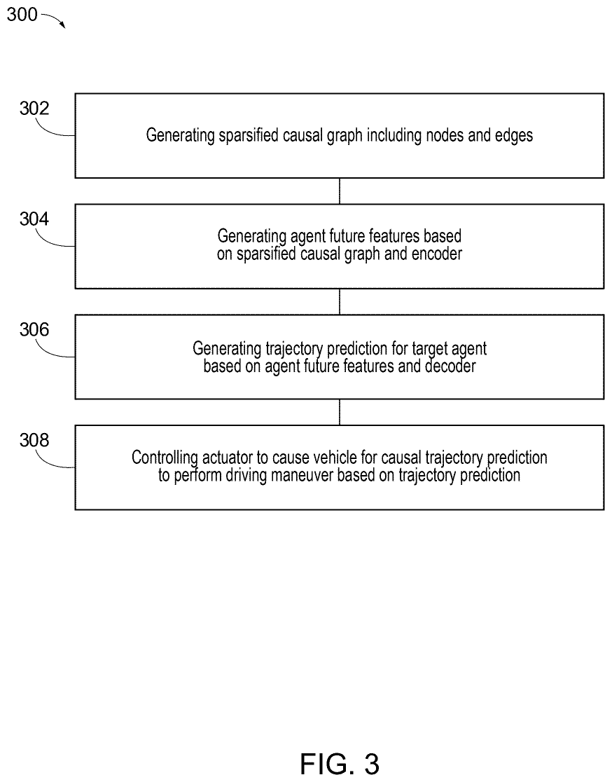

FIG. 3 is an exemplary flow diagram of a computer-implemented method 300 for causal trajectory prediction, according to one aspect. The computer-implemented method 300 for causal trajectory prediction may include generating 302 a sparsified causal graph including two or more nodes and two or more edges. A node of the two or more nodes may represent an agent of one or more agents within an environment. An edge of the two or more edges between a first node and a second node may represent a causal relationship between the first node and the second node. The computer-implemented method for causal trajectory prediction may include generating 304 one or more agent future features based on the sparsified causal graph and an encoder, generating 306 a trajectory prediction for a target agent based on the one or more agent future features and a decoder, and controlling 308 an actuator to cause a vehicle for causal trajectory prediction to perform a driving maneuver based on the trajectory prediction for the target agent.

The generating of the sparsified causal graph may be based on regularized Bernoulli distribution. The generating of the sparsified causal graph may be based on an entmax function or a softmax function. The computer-implemented method for causal trajectory prediction may include generating a coarse trajectory prediction for one or more of the agents within the environment based on one or more of the agent future features and generating the trajectory prediction for the target agent based on the coarse trajectory prediction for one or more of the agents.

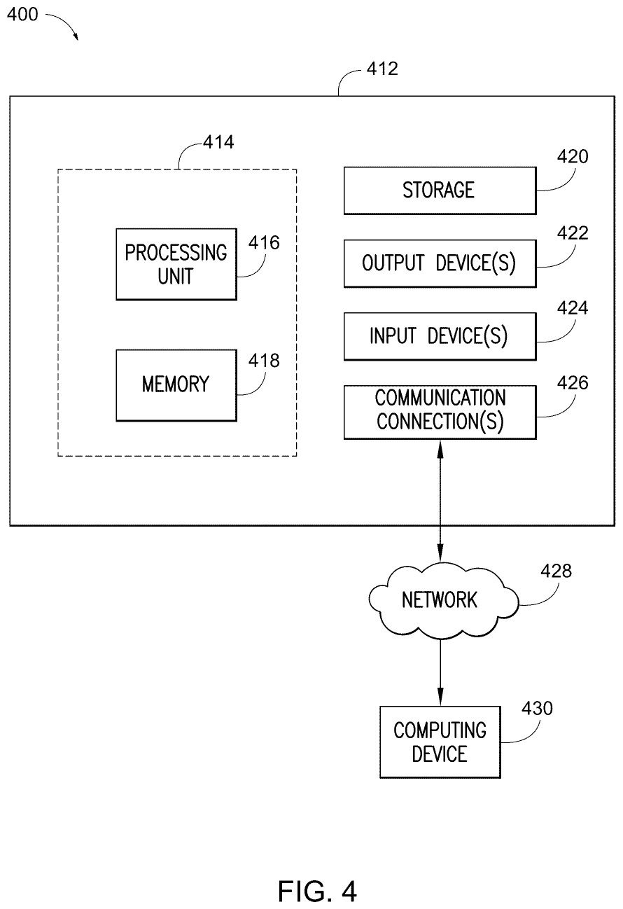

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions may be combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

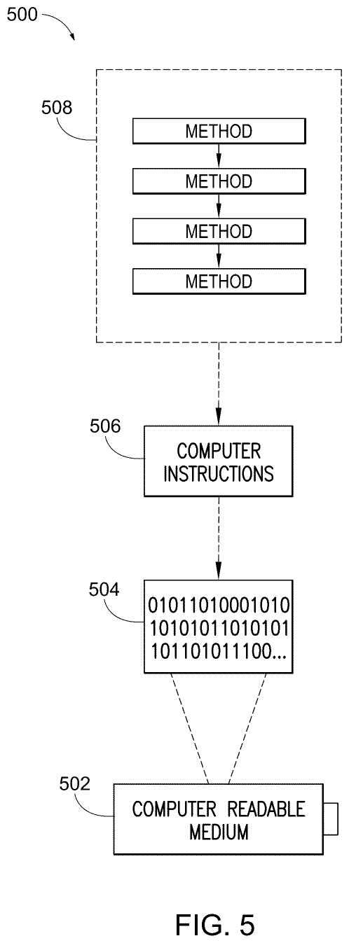

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 300 for causal trajectory prediction of FIG. 3. In another aspect, the processor-executable computer instructions 506 may be configured to implement a system, such as the system 100 for causal trajectory prediction of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for causal trajectory prediction, comprising:
a memory storing one or more instructions; and
a processor executing one or more of the instructions stored on the memory to perform:
generating a sparsified causal graph including two or more nodes and two or more edges, wherein a node of the two or more nodes represents an agent of one or more agents within an environment and wherein an edge of the two or more edges between a first node and a second node represents a causal relationship between the first node and the second node;
generating one or more agent future features based on the sparsified causal graph and an encoder; and
generating a trajectory prediction for a target agent based on the one or more agent future features and a decoder.

2. The system for causal trajectory prediction of claim 1, comprising:
an actuator, wherein the processor controls the actuator to cause the system for causal trajectory prediction to perform a driving maneuver based on the trajectory prediction for the target agent.

3. The system for causal trajectory prediction of claim 1, wherein the processor generates the sparsified causal graph based on regularized Bernoulli distribution.

4. The system for causal trajectory prediction of claim 1, wherein the processor generates the sparsified causal graph based on an entmax function or a softmax function.

5. The system for causal trajectory prediction of claim 1, wherein the processor generates a coarse trajectory prediction for one or more of the agents within the environment based on one or more of the agent future features.

6. The system for causal trajectory prediction of claim 5, wherein the processor generates the trajectory prediction for the target agent based on the coarse trajectory prediction for one or more of the agents.

7. The system for causal trajectory prediction of claim 1, wherein the processor generates the sparsified causal graph based on an adjacency matric and sparse self-attention.

8. The system for causal trajectory prediction of claim 1, wherein the system for causal trajectory prediction is equipped on an autonomous vehicle.

9. The system for causal trajectory prediction of claim 1, wherein the encoder includes one or more encoder layers and in each encoder layer, a message is only passed from each agent's parents to each agent itself.

10. The system for causal trajectory prediction of claim 1, wherein the decoder includes one or more decoder layers and in each decoder layer, a message is only passed from each agent's parents to each agent itself.

11. A computer-implemented method for causal trajectory prediction, comprising:
generating a sparsified causal graph including two or more nodes and two or more edges, wherein a node of the two or more nodes represents an agent of one or more agents within an environment and wherein an edge of the two or more edges between a first node and a second node represents a causal relationship between the first node and the second node;
generating one or more agent future features based on the sparsified causal graph and an encoder; and
generating a trajectory prediction for a target agent based on the one or more agent future features and a decoder.

12. The computer-implemented method for causal trajectory prediction of claim 11, comprising controlling an actuator to cause a vehicle for causal trajectory prediction to perform a driving maneuver based on the trajectory prediction for the target agent.

13. The computer-implemented method for causal trajectory prediction of claim 11, wherein the generating the sparsified causal graph is based on regularized Bernoulli distribution.

14. The computer-implemented method for causal trajectory prediction of claim 11, wherein the generating the sparsified causal graph is based on an entmax function or a softmax function.

15. The computer-implemented method for causal trajectory prediction of claim 11, comprising:
generating a coarse trajectory prediction for one or more of the agents within the environment based on one or more of the agent future features; and
generating the trajectory prediction for the target agent based on the coarse trajectory prediction for one or more of the agents.

16. A system for causal trajectory prediction, comprising:
an actuator;
a memory storing one or more instructions; and
a processor executing one or more of the instructions stored on the memory to perform:
generating a sparsified causal graph including two or more nodes and two or more edges, wherein a node of the two or more nodes represents an agent of one or more agents within an environment, wherein an edge of the two or more edges between a first node and a second node represents a causal relationship between the first node and the second node, and wherein the sparsified causal graph includes less edges than a full causal graph associated with the same one or more agents within the environment;
generating one or more agent future features based on the sparsified causal graph and an encoder;
generating a trajectory prediction for a target agent based on the one or more agent future features and a decoder; and
controlling the actuator to cause the system for causal trajectory prediction to perform a driving maneuver based on the trajectory prediction for the target agent.

17. The system for causal trajectory prediction of claim 16, wherein the processor generates the sparsified causal graph based on regularized Bernoulli distribution.

18. The system for causal trajectory prediction of claim 16, wherein the processor generates the sparsified causal graph based on an entmax function or a softmax function.

19. The system for causal trajectory prediction of claim 16, wherein the processor generates a coarse trajectory prediction for one or more of the agents within the environment based on one or more of the agent future features.

20. The system for causal trajectory prediction of claim 19, wherein the processor generates the trajectory prediction for the target agent based on the coarse trajectory prediction for one or more of the agents.
